(19) United States
(12) Patent Application Publication
(10) Pub. No.: US 2002/0120863 A1
(43) Pub. Date: Aug. 29, 2002

(54) Method of and apparatus for investigating transactions in a data processing environment

(75) Inventors: Siani Lynne Pearson, Bristol (GB); Graeme John Proudler, Bristol (GB)

Correspondence Address: HEWLETT-PACKARD COMPANY, Intellectual Property Administration, P.O. Box 272400, Fort Collins, CO, 80527-2400, US

(73) Assignee: Hewlett-Packard Company

(21) Appl. No.: 10/080,478

(22) Filed: Feb. 22, 2002

(30) Foreign Application Priority Data
Feb. 23, 2001 (GB) 0104580.6

(51) Int. Cl. G06F 11/30

(52) U.S. Cl. 713/200; 709/224; 705/74

(57) ABSTRACT

A method of investigating misdemeanour within a data processing system is provided. An investigator is given an anonymous authenticated identity on a trusted computing device such that a trustworthy record of transactions can be created. The investigator can participate in the transaction.

### TECHNICAL FIELD

The present invention relates to a method of and apparatus for investigating transactions, with an aim of identifying misdemeanour, in systems, institutions, or companies where such transactions are performed within a data processing environment.

### BACKGROUND ART

It has long been recognised that the power of computers can be utilised in order to commit fraud or other crimes. Some of these misdemeanours can be perpetrated by tampering with or subverting the processes run on a computer. The possibilities for committing such an act have been reduced by the advent of trusted computing platforms in which the integrity of the system is monitored through various stages of the system build commencing from power-up, loading of operating systems, and loading applications programs. However it is possible that users may take a more active role in committing fraud within a data processing environment, and in such circumstances it becomes desirable to launch an investigation.

Commencing an investigation is a highly sensitive task, especially when an investigation is being launched in one's own computing environment. Users must not be alerted to the fact that an investigation is in progress. However, this can be difficult to do since it will often be necessary to gain permission from system administrators in order to obtain the necessary access rights in order to perform the investigation properly. This can be counterproductive, especially when misdemeanour by administrators is suspected.

### DISCLOSURE OF THE INVENTION

According to a first aspect of the present invention, there is provided a method of investigating transactions in a data processing environment, which environment comprises a trusted computing environment, the method comprising the steps of:

(i) selecting a user within the trusted computing environment;

(ii) creating an investigation identity which is owned by the user;

(iii) using the investigation identity to take part in transactions; and

(iv) creating a record of those transactions.

It is thus possible to create an identity within the data environment solely for the purpose of performing the investigation. The record is trustworthy because it is created within a trusted computing environment.

In the present context, “trust” and “trusted” are used to mean that a device or service can be relied upon to work in an intended, described, or expected manner, and has not been tampered with or subverted in order to run malicious operations.

Advantageously the investigation identity is an anonymous identity. Within the context of electronic transactions, there has been growing concern over the amount of information swopped between two parties undertaking a transaction. Traditionally, in non e-commerce situations, a purchaser of a product or user of a service can go to the product or service provider and purchase that product or service anonymously if they transaction is a cash transaction. In order to overcome the perceived problem of not being able to remain anonymous, the concept of an anonymous identity has been proposed by the “trusted computing platform alliance” whose specification for a trusted computing platform can be found on their web site at www.trustedpc.org.

In essence, a user is given an electronic identity which contains no data concerning that user's physical identity. A trusted party maintains a record correlating the electronic identity with the user's physical identity. In a secure computing environment, a trusted platform is manufactured and then shipped/delivered with a manufacturer's endorsement that the device is a trusted platform. The owner of the platform chooses a privacy certification authority and enters a verification scheme, such as a TCPA protocol, involving a label chosen by the user, the trusted device in the trusted platform and the certification authority. During this process, the privacy certification authority binds the manufacturer's endorsement and the user's label into an identity certificate which is sent to the owner. This can be done a plurality of times with different certification authorities or with the same authority, thereby creating multiple identity certificates with different labels.

Consequently, parties to a transaction can be assured through the auspices of the trusted party that the entities that they arc transacting with are authentic, whilst the entities can also remain anonymous.

Advantageously a user within a trusted computing environment is the owner of a plurality of identities. For example, the user could own one identity for carrying out work related tasks, could use and own a second identity for the purposes of conducting transactions such as buying records, books or the like, the user could use and own a third identity for carrying out a certain class of transactions which the user wished to keep segregated from other transactions, for example purchasing “adult material”, and so on. In each case, each of the user's identities can be authenticated by a trusted party such that the user can undertake these transactions without his or her physical identity becoming disclosed. Of course, in the event of some misdemeanour, such as non-payment of bills, then the injured party can provide proof to the trusted party that this misdemeanour has occurred and then the trusted party can make the user's physical identity available such that the user can be pursued in order to remedy the misdemeanour.

The present invention builds upon the ability of a user to own an anonymous identity. For the purposes of the investigation, a new identity, namely an “investigation identity” is made which belongs to a selected user who has been selected by the originator of the request to perform an investigation, and by a service provider who performs the investigation, or who is the owner or operator of the trusted computing environment. Transactions using the investigation identity are preferably made by an investigator, who is not the user who owns the investigation identity.

Advantageously the user has the capability of monitoring transactions made using the investigation identity and also of suspending, removing, deleting or otherwise inhibiting the operation of the investigation identity. However, preferably, the user has no rights whatsoever to alter the record of transactions created using the investigation identity.

A description of event logging in a trusted environment can be found in the applicants copending International Patent Application Publication No. PCT/GB00/02004 entitled “Data Logging In Computer Platform”, filed on May 25, 2000, the contents of which are incorporated by reference herein.

According to a second aspect of the present invention, there is provided an apparatus for investigating transactions, the apparatus including a trusted computing device arranged such that an investigation identity is owned by a user, and that a record of transactions made by the investigation identity is stored in an authenticated record by the trusted computing device.

Advantageously the record of transactions is authenticated and cannot be edited, except to add new transactions as and when they occur. Thus, the user and/or the investigating authority using the investigation identity only has the authority to create items within the record, but not to modify or delete any existing items.

The authenticity of the record can be trusted because the record is contained within a trusted computing device and the operation of that device can be trusted because it is authenticated by a trusted party.

According to a third aspect of the present invention, there is provided a computer program for causing a trusted computing device to perform the steps of the method according to the first aspect of the present invention.

### BRIEF DESCRIPTION OF THE DRAWINGS

The present invention will further be described, by way of example, with reference to the accompanying drawings, in which:

FIG. 1 schematically illustrates a data processing arrangement including a trusted computing device which may be used for carrying out an investigation; and

FIG. 2 schematically illustrates the steps performed in carrying out an investigation.

### BEST MODE FOR CARRYING OUT THE INVENTION

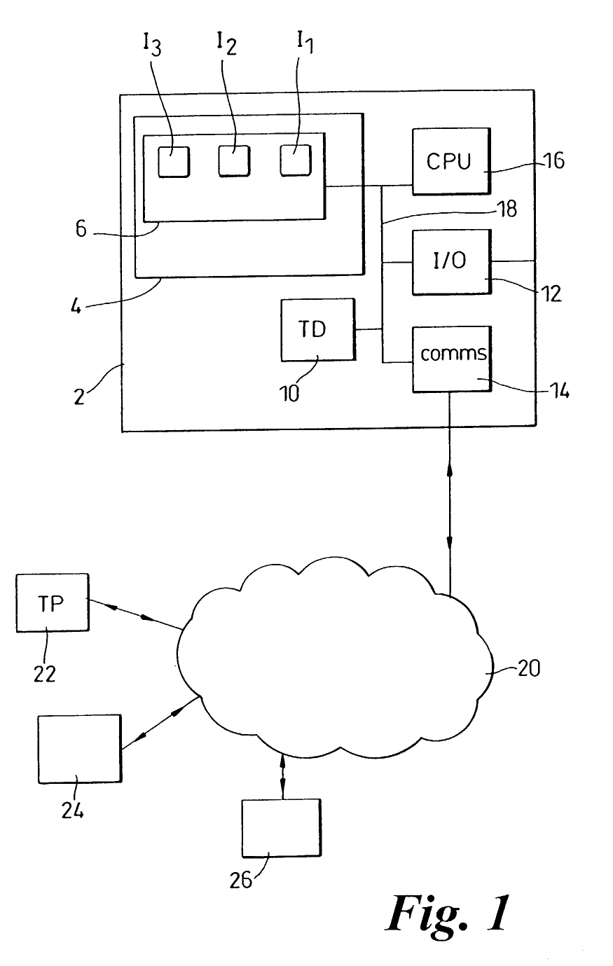

As shown in FIG. 1, a trusted computing device 2 has a memory 4, which can comprise a mass storage device such as a hard disc or tape, together with semiconductor memory such as RAM, which contains therein the information relating to a user 6 amongst other things such as an operating system, applications and data. The user may be the owner of multiple identities, labelled I₁, I₂ and I₃ in this example. The user's identity is, as noted herein before, maintained within a trusted computing device. In essence, a trusted computing device includes a trusted module 10 which takes control of the computing device 2 at power-up or reset in order to ensure that the correct BIOS environment is built within the computing device. It can do this, either by containing the BIOS within the trusted device 10 or by possessing information about the correct nature of the BIOS such that the trusted device can validate the BIOS by examining check sums or the contents at specified addresses. Once the BIOS can be trusted, the operating system can then be installed over the trusted BIOS, and again the trusted device 10 can perform tests to validate the integrity of the operating system in order to ensure that neither the operating system nor the BIOS has been subverted. The trusted computing device 2 will typically also include input/output device 12, for example for driving video displays, receiving keyboard or mouse commands, and possibly removable storage media, as well as a communications device 14 which enables the trusted computing device to communicate with other devices in a data processing environment. A central processing unit 16 communicates with the memory 4, trusted device 10, input/output device 12 and communications device 14 via a data bus 18.

An exemplary trusted computing devise is further described in the applicant's co-pending International Patent Application Publication No. PCT/GB00/00528 entitled “Trusted Computing Platform”, filed on Feb. 15, 2000, the contents of which are incorporated by reference herein. Other forms of trusted computing devices can be envisaged by the skilled person.

The trusted computing device can communicate with other devices which may be local, or remote. Such links may be established over a distributed communications network 20, such as the internet. Other parties reachable and via the distributed communications network 20 may include a trusted party 22, and investigation agency 24 and a party 26 which party may be under investigation. In use, the investigation agency is given permission to use one of the identities, I₁ to I₃ as an investigation identity with which to undertake transactions with the party 26 under investigation. Thus, for example, identity I₃ may become a proxy identity for the investigation agency. Alternatively identity I₃ may have been specially created for this task. However, the investigation agency 24 is only given the rights to use the identity I₃, the ownership of that identity remains with the user whose identity 6 is maintained within the trusted machine 2. Thus, the user maintains rights over the identity I₃, and in particular the right to suspend its use. This gives a level of control over the activities of the investigation agency 24 thereby allowing it to be brought to account and its activities to be constrained.

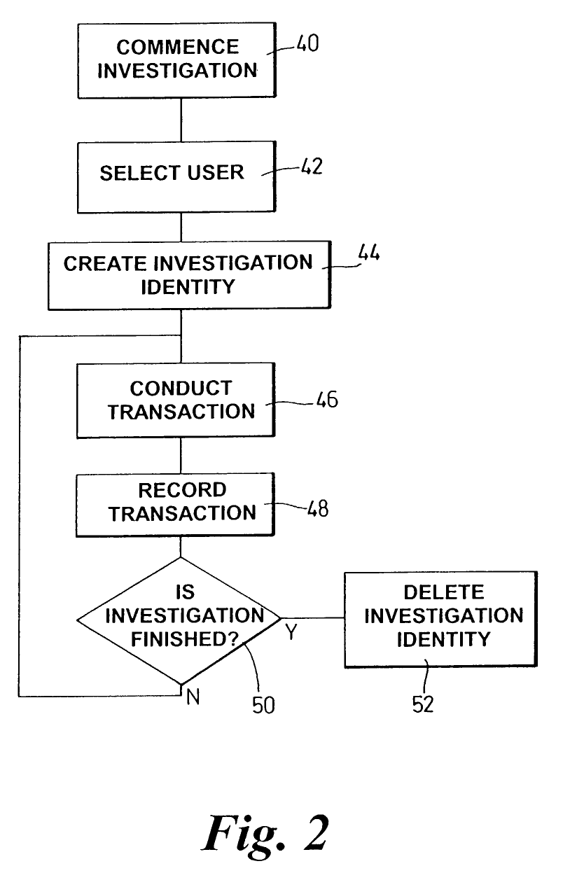

FIG. 2 schematically illustrates a method of carrying out the present invention. The method commences at step 40 where it has been agreed, either by a law enforcement agency or an organisation, that an investigation should be commenced. An approach is then made to the investigation agency 24 in order to seek their assistance in the investigation. If the agency 24 agrees to participate, an individual is then selected at step 42 and their trusted machine 2 is used as a proxy for the investigations. The consent of the individual is required since the operation of their trusted machine cannot be subverted (because it is a trusted machine) and also because an anonymous identity owned by the individual is used by the investigation agency 24.

The selected user creates, at step 44, a new anonymous identity on their trusted computing machine 2 using the trusted computing platform application mechanisms that enable such anonymous identities to be created, and then allocates this new anonymous identity, I₃, to the investigation agency 24. The investigation agency can conduct transactions at step 46 using this identity, and a signed and authenticated log of all transactions is recorded at step 48. These logs are protected against deletion or alteration via the trusted component 10 on the trusted computing device 2. These logs can then be used as evidence in proceedings against any wrong doers. Periodically a check may be made at step 50 to see if the investigation has finished, if it has not further transactions may be conducted, otherwise the investigation is terminated at step 52 with the deletion of the investigation identity.

It should be noted that transactions are not merely restricted to entrapment operations where the investigation agency participates in the transaction. Thus, the investigation identity could also be used as a recipient of information as all information received by the investigation identity is authenticated and logged. Thus such an arrangement can be invoked for the collections of testimonies. Furthermore, the authenticity of the testator can be ascertained, even though that person's true identity remains known only to the trusted party 22 in accordance with the ability of a user to create an authenticated anonymous identity.

1. A method of investigating transactions in a data processing environment comprising a trusted computing environment, the method comprising the steps of:
i. selecting a user within the trusted computing environment;
ii. creating an investigation identity which is owned by the user;
iii. using the investigation identity to take part in transactions; and
iv. creating a record of those transactions.

2. A method as claimed in claim 1, in which the investigation identity is an anonymous identity.

3. A method as claimed in claim 1, in which transactions made using the investigation identity are kept in an authenticated record by a trusted party.

4. A method as claimed in claim 1, in which the record of transactions is made available to an investigator.

5. A method as claimed in claim 1, in which the investigation identity is used by an investigator who takes part in the transactions.

6. A method as claimed in claim 1, in which the user can monitor the transactions made using the investigation identity.

7. A method as claimed in claim 1, in which the user can inhibit the operation of the investigation identity.

8. A method as claimed in claim 1 in which the trusted computing environment includes a trusted party who maintains the identities of parties to a transaction such that the identity of each party can be authenticated by other parties whilst each party is anonymous to the other parties.

9. An apparatus for investigating transactions, said apparatus including a trusted computing device arranged such that an investigation identity is owned by a user, and a record of transactions made by the investigation identity is stored in an authenticated record by the trusted computing device.

10. A computer program product for causing a trusted computing device having a trusted computing environment to perform the following steps:
i. select a user within the trusted computing environment;
ii. create an investigation identity which is owned by the user;
iii. use the investigation identity to take part in transactions; and
iv. create a record of those transactions.
